(19) United States
(12) Patent Application Publication
(10) Pub. No.: US 2026/0370907 A1
(43) Pub. Date: Nov. 19, 2026

(54) METHOD, APPARATUS, DEVICE, AND STORAGE MEDIUM FOR INTERFACE INTERACTION

(71) Applicants: Beijing Zitiao Network Technology Co., Ltd., Beijing (CN); Lemon Inc., Grand Cayman (KY)

(72) Inventors: Ke MA, Beijing (CN); Jiaying WANG, CULVER CITY, CA (US); Chunhou LI, CULVER CITY, CA (US); Xuwen QIU, CULVER CITY, CA (US); Yiliu JIANG, CULVER CITY, CA (US); Ziba ABULAITI, CULVER CITY, CA (US); Xintao SHE, CULVER CITY, CA (US); Tao REN, CULVER CITY, CA (US); Haoxiang XU, CULVER CITY, CA (US); Liangwei ZHANG, CULVER CITY, CA (US); Wenhe ZHANG, CULVER CITY, CA (US)

(21) Appl. No.: 19/679,003

(22) Filed: May 15, 2026

(30) Foreign Application Priority Data
May 15, 2025 (WO) PCT/CN2025/094995

(51) Int. Cl. H04N 21/442; H04N 21/431; H04N 21/466

(52) U.S. Cl. CPC H04N 21/44226; H04N 21/4316; H04N 21/4668

(57) ABSTRACT

A method, an electronic device, and a storage medium for interface interaction are provided. The method includes: presenting a set of content items corresponding to a set of users in an interaction interface, an association relationship between the set of users and a current user satisfying a predetermined condition, the content item including a first control configured to trigger adjustment of the association relationship between the current user and a corresponding user; presenting, in a first content item of the set of content items corresponding to the first user, a set of media contents associated with the first user; and presenting, in response to a trigger for a first media content of the set of media contents, a playback interface of a media stream to play the first media content, the media stream corresponding to the set of media contents.

This application claims to priority to PCT Application No. PCT/CN2025/094995, filed on May 15, 2025, and entitled “METHOD, APPARATUS, DEVICE, AND STORAGE MEDIUM FOR INTERFACE INTERACTION”, the entirety of which is incorporated herein by reference.

### FIELD

Example embodiments of the present disclosure generally relate to the field of computers, and in particular, to a method, an apparatus, a device, and a computer-readable storage medium for interface interaction.

### BACKGROUND

In recent years, with the continuous development of computer technologies, more and more users perform social activities on a network platform. For example, a user may post a video on a network platform, browse videos of other users, or communicate with other users through a network platform. Conventionally, when recommending other users to the current user, information about other users provided by the network platform for the current user is insufficient.

### SUMMARY

In a first aspect of the present disclosure, a method of interface interaction is provided. The method includes: presenting a set of content items corresponding to a set of users in an interaction interface, an association relationship between the set of users and a current user satisfying a predetermined condition, the content item including a first control configured to trigger adjustment of the association relationship between the current user and a user corresponding to the content item; presenting, in a first content item of the set of content items corresponding to a first user, a set of media contents associated with the first user; and presenting, in response to a trigger for a first media content of the set of media contents, a playback interface of a media stream to play the first media content, the media stream corresponding to the set of media contents.

In a second aspect of the present disclosure, an apparatus for interface interaction is provided. The apparatus includes a first presenting module configured to present a set of content items corresponding to a set of users in an interaction interface, an association relationship between the set of users and a current user satisfying a predetermined condition, the content item including a first control, and the first control being configured to trigger adjustment of the association relationship between the current user and a user corresponding to the content item; a second presenting module configured to present, in a first content item of the set of content items corresponding to a first user, a set of media content associated with the first user; and a third presenting module configured to present, in response to a trigger for a first media content of the set of media contents, a playback interface of a media stream to play the first media content, the media stream corresponding to the set of media contents.

In a third aspect of the present disclosure, an electronic device is provided. The device includes at least one processor; and at least one memory coupled to the at least one processor and storing instructions for execution by the at least one processor. The instructions, when executed by the at least one processor, cause the device to perform the method of the first aspect.

In a fourth aspect of the present disclosure, a computer-readable storage medium is provided. The computer-readable storage medium has a computer program stored thereon, and the computer program is executable by a processor to implement the method of the first aspect.

It should be understood that the content described in this content section is not intended to limit the key features or major features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, in which:

FIG. 1 illustrates a schematic diagram of an example environment in which embodiments according to the present disclosure may be implemented;

FIGS. 2A-2S illustrate example interfaces according to some embodiments of the present disclosure;

FIG. 3 illustrates a flowchart of an example process of interface interaction according to some embodiments of the present disclosure;

FIG. 4 illustrates a schematic structural block diagram of an example apparatus for interface interaction according to some embodiments of the present disclosure; and

FIG. 5 illustrates a block diagram of an electronic device capable of implementing various embodiments of the present disclosure.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as being limited to the embodiments set forth herein, but rather, these embodiments are provided for a more thorough and complete understanding of the present disclosure. It should be understood that the drawings and embodiments of the present disclosure are for exemplary purposes only and are not intended to limit the scope of the present disclosure.

It should be noted that the title of any section/subsection provided herein is not limiting. Various embodiments are described throughout and any type of embodiments may be included in any section/subsection. Furthermore, the embodiments described in any section/subsection may be combined in any manner with the same section/subsection and/or any other embodiment described in different sections/subsections.

In the description of the embodiments of the present disclosure, the terms “including” and the like should be understood as an open-ended inclusion, i.e., “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first”, “second”, and the like may refer to different or identical objects. Other explicit and implicit definitions may also be included below.

Embodiments of the present disclosure may involve data of users, acquisition and/or use of data, and the like. These aspects all follow the corresponding laws and regulations and related provisions. In the embodiments of the present disclosure, collection, obtaining, processing, handling, forwarding, usage and the like of all data are performed with the user’s knowledge and confirmation. Accordingly, when implementing the embodiments of the present disclosure, the types, the usage scope, the usage scenario, and the like of the data or information that may be involved should be notified to the user and obtain the authorization of the user in an appropriate manner according to the relevant laws and regulations. The specific notification and/or authorization manner may vary according to actual situations and application scenarios, and the scope of the present disclosure is not limited in this regard.

If the solutions described in the present specification and the embodiments involve processing of personal information processing is involved, the processing is performed on the premise of having a legality basis (for example, obtaining consent of a personal information subject, or necessary for performing a fulfillment contract), and is performed only within a specified or agreed range. The user rejects personal information other than necessary information required by the basic function, and does not affect the basic function of the user.

As mentioned above, in recent years, with the continuous development of computer technologies, more and more users perform social activities on a network platform. For example, a user may post a video on a network platform, browse videos of other users, or communicate with other users through a network platform.

Embodiments of the present disclosure provide a solution for interface interaction. The solution includes: presenting a set of content items corresponding to a set of users in an interaction interface, an association relationship between the set of users and a current user satisfying a predetermined condition, the content item including a first control configured to trigger adjustment of the association relationship between the current user and a corresponding user; presenting, in a first content item of the set of content items corresponding to a first user, a set of media content associated with the first user; and presenting, in response to a trigger for a first media content of the set of media contents, a playback interface of a media stream to play the first media content, the media stream corresponding to the set of media content. Conventionally, when recommending other users to the current user, information about other users provided by the network platform for the current user is insufficient.

In this manner, embodiments of the present disclosure provide for a current user a set of media contents associated with a first user, which may provide the current user with richer information associated with the first user. Moreover, in the embodiments of the present disclosure, after the first media content of the set of media contents is triggered, the playback interface of the media stream may be presented, so that the current user may browse the first media content more quickly, thereby improving the information obtaining efficiency.

Various example implementations of this solution are described in detail below in conjunction with the accompanying drawings.

### Example Environment

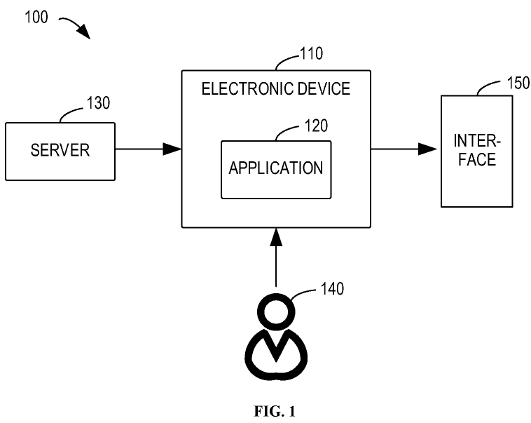

FIG. 1 illustrates a schematic diagram of an example environment 100 in which embodiments of the present disclosure may be implemented. As shown in FIG. 1, the example environment 100 may include an electronic device 110.

In this example environment 100, the electronic device 110 may run an application 120 that supports interface interaction. The application 120 may be any suitable type of application for interface interaction, examples of which may include, but are not limited to: a content sharing application, an online video application, a live application, a social application, or other suitable application. The user 140 may interact with the application 120 via the electronic device 110 and/or its attachment device.

In the environment 100 of FIG. 1, if the application 120 is in an active state, the electronic device 110 may present, via the application 120, an interface 150 for supporting interface interaction.

In some embodiments, the electronic device 110 communicates with a server 130 to enable provisioning of services to the application 120. The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 may also support any type of interface for a user (such as a “wearable” circuit, etc.).

The server 130 may be a standalone physical server, a distributed system or a server cluster composed of multiple physical servers, or may be a cloud server that provides basic cloud computing services such as cloud services, cloud databases, cloud computing, cloud functions, cloud storage, network services, cloud communications, middleware services, domain name services, security services, content distribution networks, big data and artificial intelligence platforms, or the like. The server 130 may include, for example, a computing system/server, such as a mainframe, an edge computing node, a computing device in a cloud environment, or the like. The server 130 may provide a background service for the application 120 supporting interface interaction in the electronic device 110.

A communication connection may be established between the server 130 and the electronic device 110. The communication connection may be established in a wired manner or a wireless manner. The communication connection may include, but is not limited to, a Bluetooth connection, a mobile network connection, a Universal Serial Bus (USB) connection, a Wireless Fidelity (WiFi) connection, and the like, and the embodiments of the present disclosure are not limited in this regard. In an embodiment of the present disclosure, the server 130 and the electronic device 110 may implement signaling interaction through a communication connection between the server 130 and the electronic device 110.

It should be understood that structures and functions of various elements in the environment 100 are described for illustrative purposes only and do not imply any limitation to the scope of the present disclosure.

Some example embodiments of the present disclosure will be described below with continued reference to the accompanying drawings.

### Example Interaction

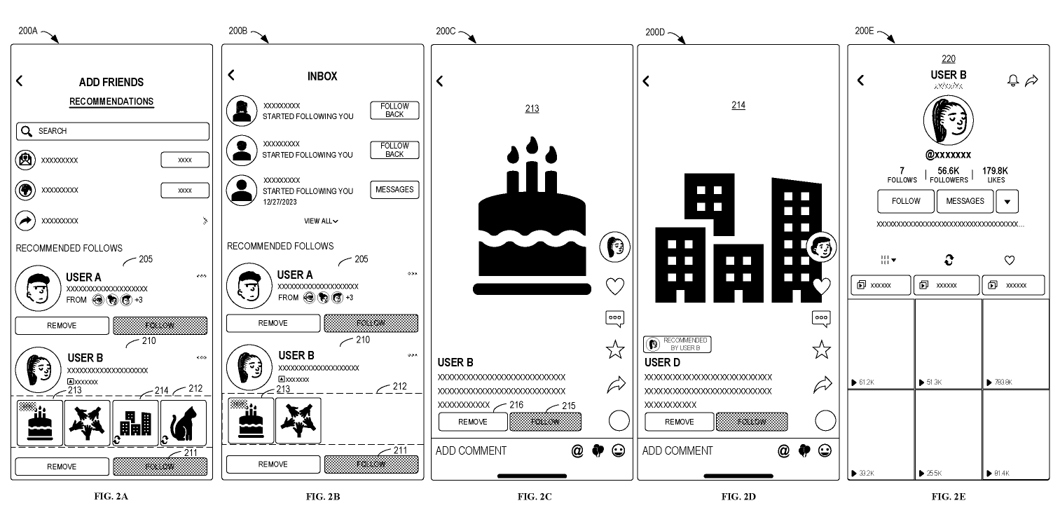

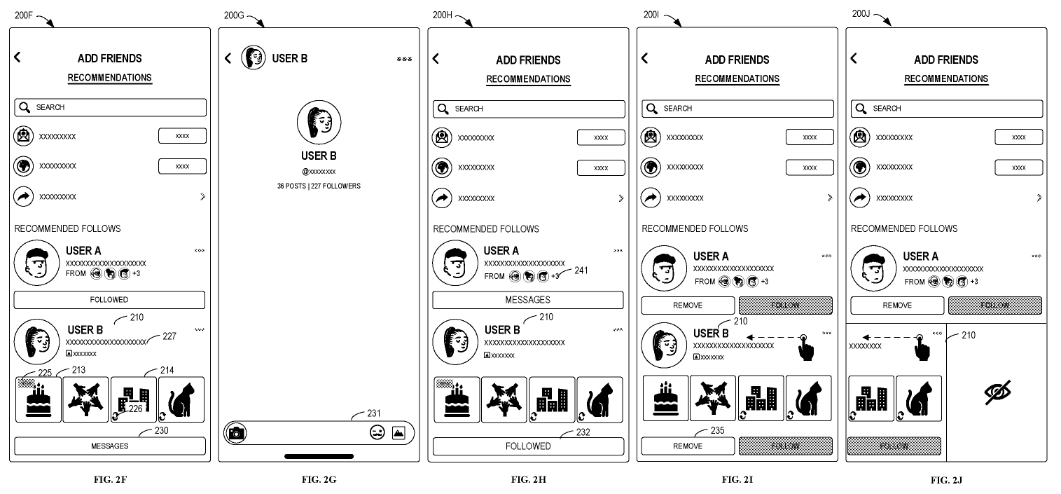

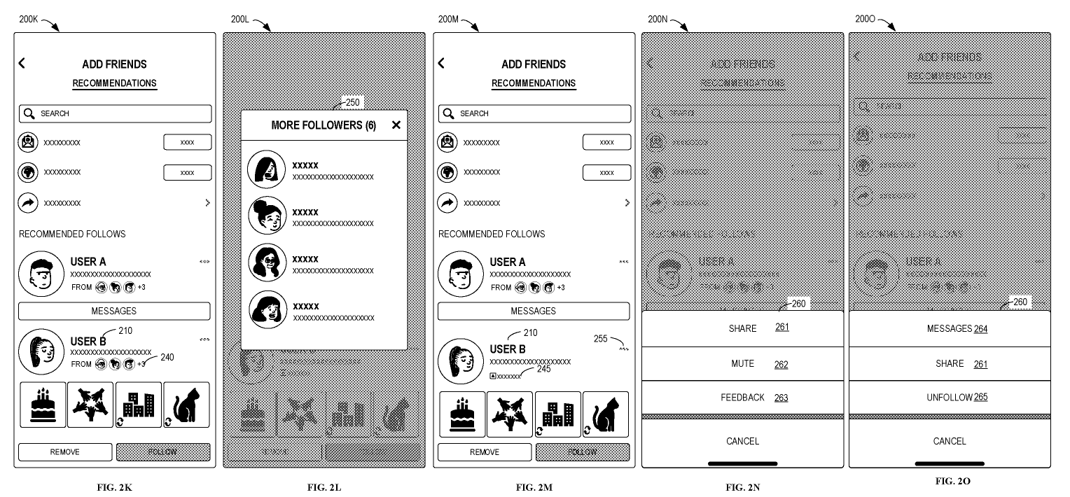

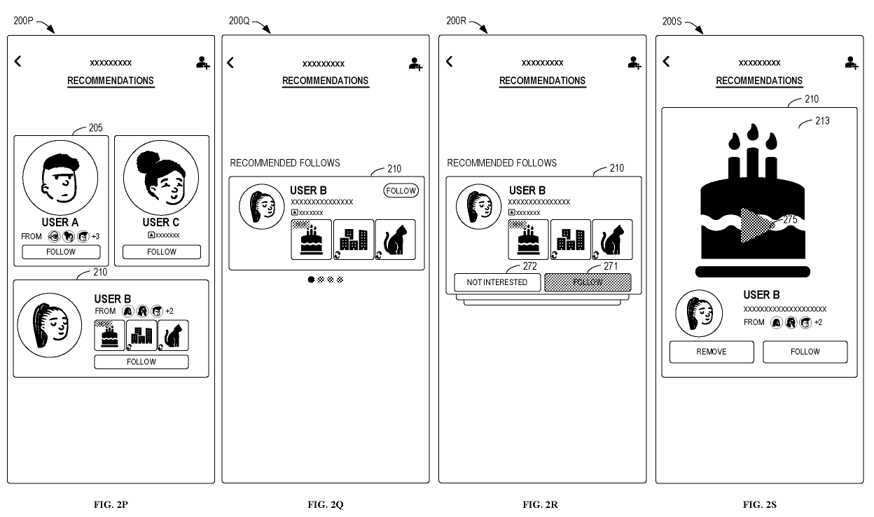

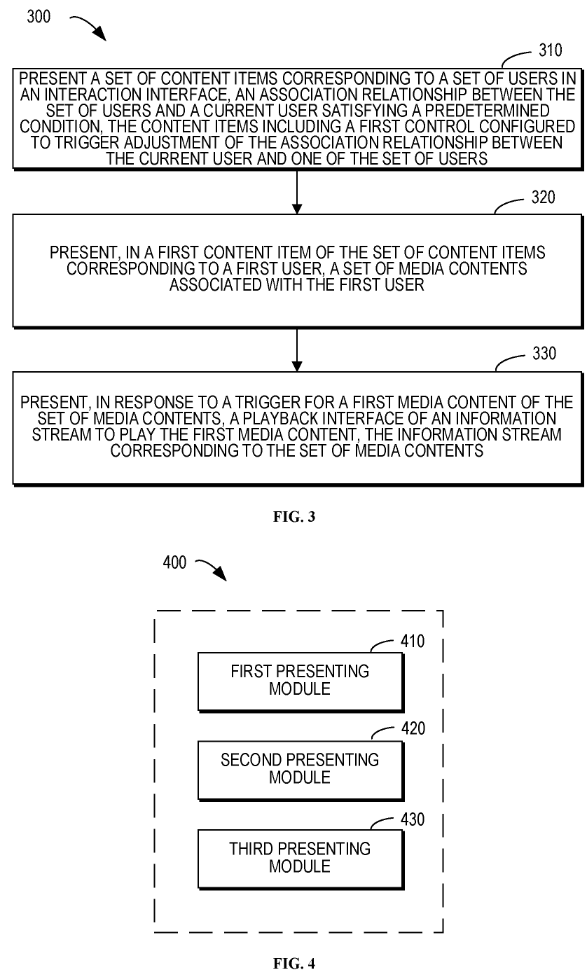

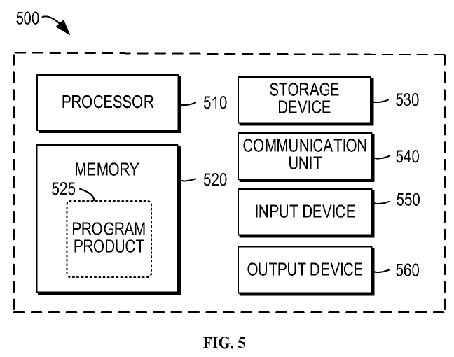

FIGS. 2A-2S illustrate example interfaces 200A-200Saccording to some embodiments of the present disclosure. The interfaces 200A to 200S may be provided, for example, by the electronic device 110 shown in FIG. 1.

In some embodiments, the electronic device 110 may present, in the interaction interface, a set of content items corresponding to a set of users. An association relationship between the set of users and a current user satisfies a predetermined condition. The content item includes a first control configured to trigger adjustment of the association relationship between the current user and a corresponding user.

As an example, as shown in FIG. 2A, the electronic device 110 may present an interaction interface. The interaction interface may be, for example, an interface 200A, and the interface 200A may be, for example, a friend adding interface. The electronic device 110 may present, in the interface 200A, a set of content items (e.g., a first content item 210 and a second content item 205) corresponding to a set of users, such as a list of content items. The list of content items includes related information of the set of users, and such related information may include, for example, information such as a name, an avatar, or the like of the set of users. For example, the electronic device 110 may present the second content item 205 and the first content item 210 in the interface 200A. The first content item 210 is associated with a first user, and the second content item 205 is associated with a second user.

In some scenarios, an association relationship between the set of users corresponding to the set of content items and a user 140 satisfies a predetermined condition. Such a predetermined condition may be, for example, the set of users following the same other users as the user 140, the set of users browsing videos posted or recommended by the user 140, or the like. Additionally or alternatively, the set of users herein may also be recommended by the server 130 to the user 140 based on historical interaction information of the interaction interface.

Further, the electronic device 110 may provide a first control in the content item. For example, the electronic device 110 may provide a first control 211 in the first content item 210. For example, the first control 211 may be referred to as a follow control. After the first control 211 (such as the follow control) is triggered by the user 140, the electronic device 110 may trigger following the first user corresponding to the first content item 210.

In some embodiments, the electronic device 110 presents, in a first content item of the set of content items corresponding to the first user, a set of media contents associated with the first user. As an example, as shown in FIG. 2A, the electronic device 110 may provide the interface 200A to the user 140, and the interface 200A may be, for example, a friend adding interface. The electronic device 110 may present, in the first content item 210 in the interface 200A (e.g., a friend adding interface), a set of media contents (e.g., a set of media contents 212) associated with the first user. The set of media contents 212 may include, for example, a first type of media content and a second type of media content. The first type of media content may be media content posted by the first user. The second type of media content may be, for example, media content recommended by the first user. The first type of media content in the set of media content 212 may be, for example, media content 213. The second type of media content may be, for example, media content 214.

In some embodiments, the electronic device 110 may present a set of media contents in a target order. Specifically, the electronic device 110 may present a set of media contents associated with the first user in a target order. The target order is determined based on temporal information associated with the set of media contents. As an example, as shown in FIG. 2A, the electronic device 110 may present a set of media contents 212 in the target order. For example, the electronic device 110 may determine a posting time of the set of media contents 212. Further, the electronic device 110 may present the set of media content 212 in the interface 200A based on a sequence of posting times of the set of media content 212.

In some embodiments, the electronic device 110 may present, in response to a trigger for the first control, the set of media contents associated with the first user in the first content item. As an example, as shown in FIG. 2B, an interaction interface presented by the electronic device 110 for the user 140 may be, for example, an interface 200B. The interface 200B may be, for example, a message viewing interface. The electronic device 110 may provide the current user with a plurality of related information of other users who follow the current user (i.e., followers of the current user) in the interface 200B. Such related information may include, for example, a name, an avatar, a following time, or the like of the follower. For example, the electronic device 110 may provide, to the user 140, information such as avatars, names of a plurality of followers who follow the user 140, and times that they followed the user 140 in the interface 200B.

When the electronic device 110 presents the first content item 210 for the user 140 in the interface 200B (e.g., a message viewing interface), the electronic device 110 may default to not presenting the media content of the corresponding user in the first content item 210 (e.g., not presenting the set of media content 212 of the first user in the first content item 210). After the first control 211 (for example, the following control) is triggered by the user 140 (that is, after the user 140 follows the first user), the electronic device 110 may then present the set of media contents 212 in the first content item 210.

Additionally or alternatively, when the electronic device 110 provides the set of media content 212 for the user 140 in the first content item 210 in the interface 200B, the electronic device 110 may only present the first type of media content in the set of media contents 212 in the first content item 210. For example, the electronic device 110 may only present media content (e.g., media content 213) of the set of media contents posted by the first user in the first content item 210.

In some embodiments, the electronic device 110 presents, in response to a trigger for a first media content of the set of media contents, a playback interface of a media stream to play the first media content. The media stream corresponds to the set of media contents. In particular, the media stream may be a feed, an information stream, or the like, or any other type of multimedia flows. As an example, as shown in FIGS. 2B and 2C, the first media content herein may be, for example, the media content 213. After the first media content (e.g., the media content 213) of the set of media contents 212 is triggered by the user 140 (e.g., clicked, double-clicked, etc. by the user 140), the electronic device 110 may present a playback interface of the media stream. The playback interface of the media stream may be, for example, an interface 200C. After the interface 200C is presented, the electronic device 110 may play the first media content (e.g., the media content 213) in the interface 200C.

In some scenarios, the electronic device 110 may further receive an interaction operation of the user 140 via the interface 200C to enable the user 140 to browse the media content in the media stream. For example, after the electronic device 110 receives a sliding operation (for example, a longitudinal sliding operation) of the user 140 via the interface 200C, the electronic device 110 may switch the first media content (for example, the media content 213) into other media content in the media stream, so that the user 140 browses the media content in the media stream.

In some embodiments, in order to be able to provide richer information for the user, the electronic device 110 may provide different media streams to the user 140 based on a type of media content selected by the user 140. Specifically, the electronic device 110 may determine, based on a type of the first media content, the media stream matching the type. The type of the first media content may include a first type or a second type. The first type corresponds to media content posted by the first user. The second type corresponds to media content recommended by the first user. The first type corresponds to a first media stream and the second type corresponds to a second media stream.

As an example, as shown in FIGS. 2A and 2C, the media content 213 is taken as an example of the first media content. When the first media content (e.g., the media content 213) is triggered by the user 140, the electronic device 110 may determine a type of the first media content (e.g., the media content 213). When it is determined that the type of the first media content (e.g., the media content 213) is the first type, that is, the first media content (e.g., the media content 213) is media content posted by the user 140, the electronic device 110 determines that the media stream corresponding to the first media content (e.g., the media content 213) is the first media stream. The first media stream may be, for example, a posting stream of the user 140, and the posting stream includes a plurality of media contents posted by the user 140. Further, the electronic device 110 may provide the first media stream to the user 140 in the playback interface 200C. For example, the electronic device 110 may provide the media content 213 in the first media stream to the user 140 in a playback interface 200D.

In some scenarios, as shown in FIGS. 2A and 2D, the media content 214 is taken as an example of the first media content. When the first media content (e.g., the media content 214) is triggered by the user 140, the electronic device 110 may determine a type of the first media content (e.g., the media content 214). When it is determined that the type of the first media content (for example, the media content 214) is the second type, that is, the first media content (for example, the media content 214) is the media content recommended by the user 140, the electronic device 110 determines that the media stream corresponding to the first media content (for example, the media content 214) is a second media stream. The second media stream may be, for example, a recommended stream of the user 140, and the recommended stream includes a plurality of media contents recommended by the user 140. Further, the electronic device 110 may provide the second media stream to the user 140 in the playback interface 200D. For example, the electronic device 110 may provide the media content 214 in the second media stream to the user 140 in the playback interface 200D.

Additionally or alternatively, as shown in FIG. 2C, the electronic device 110 may present a control 215 and a control 216 in the interface 200C. The control 215 may be referred to as a following control. When the control 215 is triggered by the user 140, the electronic device 110 may trigger the user 140 to follow the first user. The control 216 is configured to trigger removal of the first content item 210. After the control 216 is triggered by the user 140, the electronic device 110 may exit the interface 200C and re-present the interface 200A. Further, the electronic device 110 may remove the first content item 210 in the interface 200A.

In some embodiments, the electronic device 110 may switch, in response to a switching operation received in the playback interface, the playback interface to play the second media content in the media stream. The second media content corresponds to the same type as that of the first media content. As an example, as shown in FIG. 2C, the electronic device 110 may receive the switching operation of the user 140 via the playback interface 200C. Such a switching operation may be, for example, a longitudinal sliding operation by the user 140 on the playback interface 200C. Taking the first media content being the first type as an example, after receiving the switching operation, the electronic device 110 may switch the first media content in the playback interface 200C into the second media content in the first media stream. For example, if the first media content is a video posted by the user 140, the electronic device 110 may switch, after receiving the longitudinal sliding operation of the user 140 via the playback interface 200C, the first media content to the second media content posted by the user 140.

In this way, the embodiments of the present disclosure support the user 140 browsing different media streams, thereby providing better browsing experience for the user.

In some embodiments, to enable the current user (e.g., the user 140) to more flexibly view different media streams, the playback interface is configured to switch the currently presented media stream based on the interaction operation of the current user. As an example, as shown in FIG. 2C, the electronic device 110 may receive an interaction operation of the user 140 via the interface 200C. Such an interaction operation may be, for example, a transverse sliding operation by the user 140 with respect to the media content 213. After receiving the transverse sliding operation, the electronic device 110 may switch the currently presented media stream. For example, as shown in FIG. 2D, the electronic device 110 may switch the media content 213 in the currently presented first media stream to the media content 214 in the second media stream. In this way, the embodiments of the present disclosure support the user to switch the currently presented media stream through a simple interaction operation, so that the switching efficiency of the media stream can be improved, and the user can consume different media streams more conveniently, thereby improving the information obtaining efficiency.

In some scenarios, the electronic device 110 may also present a personal page of the first user. As an example, as shown in FIGS. 2B and 2E, after a user name or a user avatar of the first user in the first content item 210 is clicked by the user 140, the electronic device 110 may present a viewing interface 200E and the electronic device 110 may present a personal page 220 of the first user in the viewing interface 200E. The personal page 220 includes information associated with the first user. Such information may include, for example, a name and/or an avatar of the first user, media content posted by the first user, media content recommended by the first user, and the like.

In some embodiments, the electronic device 110 may represent a description of the first media content with different tag items. Such a description may be, for example, a posting time of the first media content, and whether the first media content is media content recommended by the user 140. Specifically, the electronic device 110 may present, in the interaction interface, a tag item associated with the first media content. The tag item indicates a description associated with the first media content.

As an example, as shown in FIG. 2F, the media content 213 is taken as an example of the first media content. The electronic device 110 may present a tag item on the media content 213. The tag item herein may be, for example, a first tag item 225. The first tag item 225 indicates that a posting time of the media content 213 is within a predetermined time period. For example, the first tag item 225 may indicate that the media content 213 is posted in the present week.

In some scenarios, as shown in FIG. 2F, the media content 214 is taken as an example of the first media content. The electronic device 110 may present a tag item on the media content 214. The tag item herein may be, for example, a second tag item 226. The second tag item 226 is configured to indicate that the media content 215 is media content recommended for the user 140.

In some embodiments, in order to provide more information related to the first user to the user 140, the electronic device 110 may also present text content configured by the first user in the first content item. Such text content may be, for example, a “personalized signature” configured by the first user. As an example, as shown in FIG. 2F, the electronic device 110 may present text content 227 configured by the first user in the first content item 210. The text content 227 is determined based on a first configuration operation of the first user, which may be, for example, a personalized signature configured by the first user, or the like.

In some embodiments, to more conveniently enable the user 140 to interact with the followed first user, the electronic device 110 may update, in response to the association relationship between the current user and the first user being adjusted, the first control in the first content item to a third control. The third control is configured to trigger sending a message to the first user.

As an example, as shown in FIGS. 2A and 2F, when the first control 211 is triggered by the user 140, the electronic device 110 may present the third control 230 in the first content item 210. The third control 230 is configured to trigger sending a message to the first user. After the control 230 is triggered by the user 140, the electronic device 110 may present a chat interface 200G of the first user as shown in FIG. 2G. The electronic device 110 may present related information of the first user in the chat interface 200G. For example, the electronic device 110 may present an avatar and/or a name of the first user, the number of followers of the first user, etc. in the chat interface 200G. Further, the electronic device 110 may provide an input control 231 to the user 140 in the chat interface 200G. The electronic device 110 may obtain input information of the user 140 via the input control 231, to send a corresponding message to the first user based on the input information.

In some scenarios, as shown in FIGS. 2A and 2H, when the first user is followed by the current user and a state of the first user satisfies a corresponding condition (for example, the state of the first user is set to not receive a message sent by others), the electronic device 110 may switch the first control 211 to a fourth control 232. The fourth control 232 displays prompt information for describing that the user 140 has followed the first user, and such prompt information may be, for example, “followed”. The fourth control 232 is configured to trigger cancellation of the first user. When the fourth control 232 is triggered by the user 140, the electronic device 110 may trigger unfollowing the first user.

In some embodiments, in order to be able to cease presentation of the first content item more flexibly, the electronic device 110 may cease presenting the first content item based on a second operation of the user. Specifically, the electronic device 110 may cease presenting the first content item in response to receiving the second operation. The second operation is associated with the first content item. The second operation includes a trigger operation on a second control in the first content item, or a sliding operation on the first content item in a predetermined direction.

As an example, as shown in FIG. 2I, the electronic device 110 may receive a second operation of the user 140 via the first content item 210. The second operation is configured to trigger the electronic device 110 to cease presenting the first content item 210. For example, the electronic device 110 may present a second control 235 in the first content item 210. The second control 235 is configured to trigger ceasing presenting the first content item. When the electronic device 110 may receive a trigger operation (e.g., a click operation, a double-click operation, etc.) for the second control 235 by the user 140. After the second control 235 is triggered, the electronic device 110 may cease presenting the first content item 210 in an interface 200I.

In some scenarios, the second operation may be, for example, a sliding operation by the user 140 on the first content item in a predetermined direction. Such a sliding operation may be, for example, a transverse sliding operation of the user 140 for the first content item 210. The transverse sliding operation may be, for example, left sliding or right sliding. After the electronic device 110 receives the transverse sliding operation for the first content item 210, as shown in FIG. 2J, the electronic device 110 may move the first content item 210 based on a direction indicated by the transverse sliding operation until the first content 210 is moved out of the interface 200J.

In this way, the embodiments of the present disclosure are capable of triggering an event of ceasing presentation of the first content item more flexibly and quickly.

In some embodiments, to provide more information related to the first user to the user 140, the electronic device 110 may present, in the first content item, a visual element associated with at least one associated user. The at least one associated user has a predetermined association relationship with both the first user and the current user.

As an example, as shown in FIG. 2K, the electronic device 110 may present a visual element 240 in the first content item 210. The visual element 240 includes at least one avatar associated with the user. The at least one associated user herein has a predetermined association relationship with both the first user and the current user (for example, the user 140). For example, the predetermined association relationship here may be that the at least one associated user is a common friend of the first user and the current user.

In some embodiments, the electronic device 110 may present, in response to receiving a first operation, description information associated with the at least one associated user. The first operation is associated with the visual element. As an example, as shown in FIGS. 2K and 2L, when the visual element 240 is triggered by the user 140, the electronic device 110 may present a viewing panel 250. The electronic device 110 may provide the description information associated with the at least one associated user to the user 140 in the viewing panel 250. For example, the electronic device 110 may provide an avatar, a name, and a “personalized signature”, etc., of the at least one associated user to the user in the viewing panel 250. The at least one associated user here may be, for example, a common friend of the first user and the current user.

In some scenarios, as shown in FIG. 2M, the electronic device 110 may also present an element 245 in the first content item 210. The element 245 indicates why the first content item 210 is presented in the interface 200M. For example, the element 245 may indicate that the first content item 210 is presented in the interface 200M as a result of the first user has browsed the video posted by the current user.

In some embodiments, the electronic device 110 may present, in response to receiving a third operation associated with the first content item, an interaction panel associated with the first content item. A set of interaction controls provided in the interaction panel is determined based on an association relationship between the current user and the first user.

As an example, as shown in FIG. 2M, the electronic device 110 may provide a configuration control in the first content item 210. Such a configuration control may be, for example, a configuration control 255. After the configuration control 255 is triggered, as shown in FIG. 2N, the electronic device 110 may present an interaction panel 260 in an interface 200N. The interaction panel 260 includes a set of interaction controls, and the set of interaction controls herein may be determined by the server 130 or the electronic device 110 based on an association relationship between the current user and the first user. When the current user does not follow the first user, the electronic device 110 may provide a sharing control 261, a stop recommendation control 262, and a feedback control 264 to the current user in the interaction panel 260. The sharing control 261 is configured to trigger a recommendation of the first content item 210 associated with the first user. The stop recommendation control 262 is configured to trigger stopping recommending the first user. When the current user has followed the first user, as shown in FIG. 2O, the electronic device 110 may provide a chat control 264, the sharing control 261, and an unfollow control 265 to the current user in the control interaction panel 260. The chat control 264 is configured to trigger presentation of a chat interface of the first user.

In some embodiments, the set of content items further includes a second content item corresponding to the second user. A first layout of the first content item is different from a second layout of the second content item. The first layout and/or the second layout is determined based on whether a media content associated with a corresponding user is obtained.

As an example, as shown in FIG. 2P, the electronic device 110 may present, in an interface 200P, a first content item 210 associated with the first user and a second content item 205 associated with the second user. As the electronic device 110 is able to obtain the media content associated with the first user (for example, the first user has previously posted or recommended a video, and the posted and recommended video is in an available state). Thus, the electronic device 110 may use the first layout to present the first content item 210 in the interface 200P. For example, the electronic device 110 may use a landscape card layout style to present the first content item 210 in the interface 200P.

In some scenarios, since the electronic device 110 cannot obtain the media content associated with the second user (for example, the second user does not post or recommend the video, or showing of posting or recommendation by the second user in an unavailable state). Thus, the electronic device 110 may use the second layout to present the second content item 205 in the interface 200P. For example, the electronic device 110 may use a vertical card layout style to present the second content item 205 in the interface 200P.

In this way, the embodiments of the present disclosure are capable of presenting different content items in the interaction interface through different layout styles, so that the effect of interface interaction can be enriched, and a better interaction experience can be provided for the user.

In some embodiments, the electronic device 110 may receive a switching operation of the user 140, and switch the content item in the interaction interface. As shown in FIG. 2Q, the electronic device 110 may receive the switching operation of the user 140 via the first content item 210. The switching operation herein may be, for example, a sliding operation (for example, left sliding or right sliding) by the user 140 on the first content item 210. Upon receiving the switching operation, the electronic device 110 may switch the first content item 210 to a second content item of the set of content items.

In some scenarios, as shown in FIG. 2R, when the electronic device 110 presents a set of content items in the interface 200R, the set of content items may be stacked and the first content item 210 is presented at the top of the stacked set of content items. After receiving the selection of a control 271 or a control 272 by the user 140, the electronic device 110 may switch the first content item 210 into the second content item of the set of content items. The control 271 is configured to trigger following the first user. The control 272 is configured to trigger cancellation of the presentation of the first content item 210.

In some other scenarios, as shown in FIG. 2S, when the electronic device 110 presents the media content in the first content item 210, the first media content 213 associated with the first user may be taken as a background of the first content item 210. The electronic device 110 may also present a playback control 275 in the first content item 210. After the playback control 275 is triggered by the user, the electronic device 110 may play the first media content 213 in the first content item 210.

In this manner, the embodiments of the present disclosure provide a set of media content associated with a first user for a current user, which may provide richer information associated with the first user for the current user. Moreover, in the embodiments of the present disclosure, after the first media content of the set of media content is triggered, the playback interface of the media stream may be presented, so that the current user may browse the first media content more quickly, thereby improving the information obtaining efficiency.

### Example Process

FIG. 3 illustrates a flowchart of an example process 300 of interface interaction according to some embodiments of the present disclosure. The process 300 may be implemented at the electronic device 110. The process 300 is described below with reference to FIG. 1.

As shown in FIG. 3, at block 310, the electronic device 110 presents a set of content items corresponding to a set of users in an interaction interface. An association relationship between the set of users and a current user satisfies a predetermined condition, and the content item includes a first control configured to trigger adjustment of the association relationship between the current user and a corresponding user.

At block 320, the electronic device 110 presents, in a first content item of the set of content items corresponding to a first user, a set of media content associated with the first user.

At block 330, the electronic device 110 presents, in response to a trigger for a first media content of the set of media contents, a playback interface of a media stream to play the first media content. The media stream corresponds to the set of media contents.

In some embodiments, presenting, in the first content item of the set of content items corresponding to the first user, the set of media content associated with the first user includes: presenting, in response to a trigger for the first control, the set of media contents associated with the first user in the first content item.

In this way, the embodiments of the present disclosure are capable of providing richer information for the user, thereby improving the information obtaining efficiency.

In some embodiments, the process 300 further includes: determining, based on a type of the first media content, the media stream matching the type.

In this way, the embodiments of the present disclosure are capable of providing the user with the media stream corresponding to the type of the first media content, so that the user may better browse the media stream.

In some embodiments, the type includes: a first type corresponding to media content posted by the first user; or a second type corresponding to media content recommended by the first user.

In this way, the embodiments of the present disclosure are capable of dividing the media content based on the type of the media content, so that the layout of the media content in the content item can be optimized, and a better interaction experience can be provided for the user.

In some embodiments, the first type corresponds to a first media stream, the second type corresponds to a second media stream, and the playback interface is configured to switch a currently presented media stream based on an interaction operation of the current user.

In this way, the embodiments of the present disclosure are capable of performing switching of the media stream more flexibly, thereby improving the efficiency with which the user obtains content from the media stream.

In some embodiments, the process 300 further includes: switching, in response to a switching operation received in the playback interface, the playback interface to play a second media content in the media stream. The second media content corresponds to the same type as that of the first media content.

In this way, the embodiments of the present disclosure enable the user to browse content in the media stream more conveniently.

In some embodiments, the process 300 further includes: presenting, in the interaction interface, a tag item associated with the first media content. The tag item indicates a description associated with the first media content.

In this way, the embodiments of the present disclosure are capable of distinguishing states of different media contents through the tag item, thereby providing more information to the current user.

In some embodiments, the process 300 further includes: presenting, in the first content item, a text content configured by the first user.

In this way, the embodiments of the present disclosure are capable of presenting the text content configured by the first user in the first content item, thereby providing more information to the current user.

In some embodiments, the process 300 further includes: presenting, in the first content item, a visual element associated with at least one associated user, the at least one associated user having a predetermined association relationship with both the first user and the current user.

In this way, the embodiments of the present disclosure are capable of providing the visual element associated with the at least one associated user to the user, so that more information can be provided for the user, thereby improving the information obtaining efficiency.

In some embodiments, the process 300 further includes: presenting, in response to receiving a first operation, description information associated with the at least one associated user. The first operation is associated with the visual element.

In this way, the embodiments of the present disclosure are capable of providing more information for the user, thereby improving the information obtaining efficiency.

In some embodiments, the process 300 further includes: ceasing, in response to receiving a second operation, presentation of the first content item. The second operation is associated with the first content item.

In this way, the embodiments of the present disclosure are capable of triggering ceasing presentation of the first content item, so that the interaction interface is more concise, thereby improving the interaction experience of the user.

In some embodiments, the second operation includes: a triggering operation on a second control in the first content item, or a sliding operation on the first content item in a predetermined direction.

In this way, the embodiments of the present disclosure are capable of triggering ceasing presentation of the first content item more flexibly.

In some embodiments, the process 300 further includes: updating, in response to the association relationship between the current user and the first user being adjusted, the first control in the first content item to a third control. The third control is configured to trigger sending a message to the first user.

In this way, the embodiments of the present disclosure are capable of sending a message to the first user more efficiently.

In some embodiments, the process 300 further includes: presenting, in response to receiving a third operation associated with the first content item, an interaction panel associated with the first content item. A set of interaction controls provided in the interaction panel is determined based on the association relationship between the current user and the first user.

In this way, the embodiments of the present disclosure are capable of providing the interaction control to the user based on the association relationship between the current user and the first user, so that the interaction process can be enriched.

In some embodiments, presenting the set of media content associated with the first user includes: presenting, in a target order, the set of media contents associated with the first user. The target order is determined based on temporal information associated with the set of media contents.

In this way, the embodiments of the present disclosure are capable of ranking a set of media contents based on the temporal information, so that the temporal information of the set of media contents may be presented in the content item, thereby improving the information obtaining efficiency.

In some embodiments, the set of content items further includes a second content item corresponding to a second user, and a first layout of the first content item is different from a second layout of the second content item.

In this way, the embodiments of the present disclosure are capable of presenting the first content item and the second content item through different layouts, so that the user may better distinguish different content items.

In some embodiments, the first layout and/or the second layout is determined based on whether a media content associated with a corresponding user is obtained.

In this way, the embodiments of the present disclosure are capable of presenting the first content item and the second content item through different layouts, so that the user may better distinguish different content items.

### Example Apparatus and Device

Embodiments of the present disclosure also provide a corresponding apparatus for implementing the above method or process. FIG. 4 shows a schematic structural block diagram of an example apparatus 400 for interface interaction according to some embodiments of the present disclosure. The apparatus 400 may be implemented or included in the electronic device 110. Various modules/components in the apparatus 400 may be implemented by hardware, software, firmware, or any combination thereof.

As shown in FIG. 4, the apparatus 400 includes: a first presenting module 410 configured to present a set of content items corresponding to a set of users in an interaction interface, an association relationship between the set of users and a current user satisfying a predetermined condition, the content item including a first control, and the first control being configured to trigger adjustment of the association relationship between the current user and a corresponding user; a second presenting module 420 configured to present, in a first content item of the set of content items corresponding to a first user, a set of media content associated with the first user; and a third presenting module 430 configured to present, in response to a trigger for a first media content of the set of media contents, a playback interface of a media stream to play the first media content, the media stream corresponding to the set of media contents.

In some embodiments, the second presenting module 420 is further configured to present, in response to a trigger for the first control, the set of media contents associated with the first user in the first content item.

In some embodiments, the apparatus 400 further includes a type determining module configured to determine, based on a type of the first media content, the media stream matching the type.

In some embodiments, the type includes: a first type corresponding to media content posted by the first user; or a second type corresponding to media content recommended by the first user.

In some embodiments, the first type corresponds to a first media stream, the second type corresponds to a second media stream, and the playback interface is configured to switch a currently presented media stream based on an interaction operation of the current user.

In some embodiments, the apparatus 400 further includes a switching module configured to switch, in response to a switching operation received in the playback interface, the playback interface to play a second media content in the media stream, the second media content corresponding to the same type as that of the first media content.

In some embodiments, the apparatus 400 further includes a tag presenting module configured to present, in the interaction interface, a tag item associated with the first media content, the tag item indicating a description associated with the first media content.

In some embodiments, the apparatus 400 further includes a text presenting module configured to present, in the first content item, a text content configured by the first user.

In some embodiments, the apparatus 400 further includes a visual element presenting module configured to present, in the first content item, a visual element associated with at least one associated user, the at least one associated user having a predetermined association relationship with both the first user and the current user.

In some embodiments, the apparatus 400 further includes an information presenting module configured to present, in response to receiving a first operation, description information associated with the at least one associated user. The first operation is associated with the visual element.

In some embodiments, the apparatus 400 further includes a removing module configured to cease, in response to receiving a second operation, presentation of the first content item. The second operation is associated with the first content item.

In some embodiments, the second operation includes: a triggering operation on a second control in the first content item, or a sliding operation on the first content item in a predetermined direction.

In some embodiments, the apparatus 400 further includes an updating module configured to update, in response to the association relationship between the current user and the first user being adjusted, the first control in the first content item to a third control, and the third control being configured to trigger sending a message to the first user.

In some embodiments, the apparatus 400 further includes a panel presenting module configured to present, in response to receiving a third operation associated with the first content item, an interaction panel associated with the first content item, where a set of interaction controls provided in the interaction panel is determined based on the association relationship between the current user and the first user.

In some embodiments, the second presenting module 420 is further configured to present, in a target order, the set of media contents associated with the first user, where the target order is determined based on temporal information associated with the set of media contents.

In some embodiments, the set of content items further includes a second content item corresponding to a second user, and a first layout of the first content item is different from a second layout of the second content item.

In some embodiments, the first layout and/or the second layout is determined based on whether a media content associated with a corresponding user is obtained.

The modules included in the apparatus 400 may be implemented in various manners, including software, hardware, firmware, or any combination thereof. In some embodiments, one or more modules may be implemented using software and/or firmware, such as machine-executable instructions stored on a storage medium. In addition to or as an alternative to machine-executable instructions, some or all of units in the apparatus 400 may be implemented, at least in part, by one or more hardware logic components. By way of example and not limitation, example types of hardware logic components that may be used include field programmable gate arrays (FPGAs), application specific integrated circuits (ASICs), application specific standards (ASSPs), system-on-a-chip (SOCs), complex programmable logic devices (CPLDs), and the like.

FIG. 5 illustrates a block diagram of an electronic device 500 in which one or more embodiments of the present disclosure may be implemented. It should be understood that the electronic device 500 illustrated in FIG. 5 is merely illustrative and should not constitute any limitation on the functionality and scope of the embodiments described herein. The electronic device 500 shown in FIG. 5 may be configured to implement the electronic device 110 as discussed above.

As shown in FIG. 5, the electronic device 500 is in the form of a general-purpose electronic device. Components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and capable of performing various processes according to programs stored in the memory 520. In a multiprocessor system, a plurality of processing units execute computer-executable instructions in parallel to improve the parallel processing capability of the electronic device 500.

The electronic device 500 generally includes a plurality of computer storage media. Such media may be any available media that is accessible to the electronic device 500, including, but not limited to, volatile and non-volatile media, removable and non-removable media. The memory 520 may be a volatile memory (e.g., a register, a cache, a random access memory (RAM)), a non-volatile memory (e.g., a read-only memory (ROM), an electrically erasable programmable read-only memory (EEPROM), a flash memory), or some combination thereof. The storage device 530 may be a removable or non-removable medium and may include a machine-readable medium, such as a flash drive, a magnetic disk, or any other medium, which may be capable of storing information and/or data and may be accessed within the electronic device 500.

The electronic device 500 may further include additional removable/non-removable, volatile/non-volatile storage media. Although not shown in FIG. 5, a disk drive for reading from or writing into a removable, nonvolatile magnetic disk (e.g., a “floppy disk”) and an optical disk drive for reading from or writing into a removable, nonvolatile optical disk may be provided. In these cases, each drive may be connected to a bus (not shown) by one or more data media interfaces. The memory 520 may include a computer program product 525 having one or more program modules configured to perform various methods or actions of various embodiments of the present disclosure.

The communication unit 540 is configured to communicate with another electronic device through a communication medium. Additionally, the functionality of components of the electronic device 500 may be implemented in a single computing cluster or multiple computing machines capable of communicating through a communication connection. Thus, the electronic device 500 may operate in a networked environment using logical connections with one or more other servers, a network personal computer (PCs), or another network node.

The input device 550 may be one or more input devices such as a mouse, a keyboard, a trackball, or the like. The output device 560 may be one or more output devices, such as a display, a speaker, a printer, or the like. The electronic device 500 may also communicate with one or more external devices (not shown) through the communication unit 540 as needed, the external devices such as a storage device, a display device, etc., communicates with one or more devices that enable the user to interact with the electronic device 500, or communicates with any device (e.g., a network card, a modem, etc.) that enables the electronic device 500 to communicate with one or more other electronic devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable medium and including computer-executable instructions, and the computer-executable instructions being executed by the processor to implement the method described above.

Aspects of the present disclosure are described herein with reference to flowcharts and/or block diagrams of a method, an apparatus, a device, and a computer program product implemented in accordance with the present disclosure. It should be understood that each block of the flowchart and/or block diagram, and combinations of blocks in the flowchart(s) and/or block diagram(s), may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in one or more blocks in the flowchart(s) and/or block diagram(s). These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in one or more blocks in the flowchart(s) and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in one or more blocks in the flowchart(s) and/or block diagram(s).

The flowchart and block diagrams in the figures show architecture, functionality, and operation that may be possibly implemented by a system, a method, and a computer program product according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagram(s) and/or flowchart(s), as well as combinations of blocks in the block diagram(s) and/or flowchart(s), may be implemented with a dedicated hardware-based system that performs the specified functions or actions, or may be implemented in a combination of dedicated hardware and computer instructions.

Various implementations of the present disclosure have been described above, which are illustrative, not exhaustive, and are not limited to the implementations disclosed. Many modifications and variations will be apparent to those of ordinary skill in the art without departing from the scope and spirit of various implementations illustrated. The selection of the terms used herein is intended to best explain the principles of the implementations, practical applications, or improvements to techniques in the marketplace, or to enable others of ordinary skill in the art to understand the various implementations disclosed herein.

1. A method of interface interaction, comprising:
presenting a set of content items corresponding to a set of users in an interaction interface, an association relationship between the set of users and a current user satisfying a predetermined condition, the content item comprising a first control configured to trigger adjustment of the association relationship between the current user and a user corresponding to the content item;
presenting, in a first content item of the set of content items corresponding to a first user, a set of media contents associated with the first user; and
presenting, in response to a trigger for a first media content of the set of media contents, a playback interface of a media stream to play the first media content, the media stream corresponding to the set of media contents.

2. The method of claim 1, wherein presenting, in the first content item of the set of content items corresponding to the first user, the set of media contents associated with the first user comprises:
presenting, in response to a trigger for the first control, the set of media contents associated with the first user in the first content item.

3. The method of claim 1, further comprising:
determining, based on a type of the first media content, the media stream matching the type.

4. The method of claim 3, wherein the type comprises:
a first type corresponding to media content posted by the first user; or
a second type corresponding to media content recommended by the first user.

5. The method of claim 4, wherein the first type corresponds to a first media stream, the second type corresponds to a second media stream, and the playback interface is configured to switch a currently presented media stream based on an interaction operation of the current user.

6. The method of claim 3, further comprising:
switching, in response to a switching operation received in the playback interface, the playback interface to play a second media content in the media stream, the second media content corresponding to the same type as that of the first media content.

7. The method of claim 1, further comprising:
presenting, in the interaction interface, a tag item associated with the first media content, the tag item indicating a description associated with the first media content.

8. The method of claim 1, further comprising:
presenting, in the first content item, a text content configured by the first user.

9. The method of claim 1, further comprising:
presenting, in the first content item, a visual element associated with at least one associated user, the at least one associated user having a predetermined association relationship with both the first user and the current user.

10. The method of claim 9, further comprising:
presenting, in response to receiving a first operation, description information associated with the at least one associated user, the first operation being associated with the visual element.

11. The method of claim 1, further comprising:
ceasing, in response to receiving a second operation, presentation of the first content item, the second operation being associated with the first content item.

12. The method of claim 11, wherein the second operation comprises:
a triggering operation on a second control in the first content item, or
a sliding operation on the first content item in a predetermined direction.

13. The method of claim 1, further comprising:
updating, in response to the association relationship between the current user and the first user being adjusted, the first control in the first content item to a third control configured to trigger sending a message to the first user.

14. The method of claim 1, further comprising:
presenting, in response to receiving a third operation associated with the first content item, an interaction panel associated with the first content item, wherein a set of interaction controls provided in the interaction panel is determined based on the association relationship between the current user and the first user.

15. The method of claim 1, wherein presenting the set of media contents associated with the first user comprises:
presenting, in a target order, the set of media contents associated with the first user, wherein the target order is determined based on temporal information associated with the set of media contents.

16. The method of claim 1, wherein the set of content items further comprises a second content item corresponding to a second user, and a first layout of the first content item is different from a second layout of the second content item.

17. The method of claim 16, wherein at least one of the first layout or the second layout is determined based on whether a media content associated with a corresponding user is obtained.

18. An electronic device, comprising:
at least one processor; and
at least one memory coupled to the at least one processor and storing instructions for execution by the at least one processor, wherein the instructions, when executed by the at least one processor, cause the electronic device to perform acts comprising:
presenting a set of content items corresponding to a set of users in an interaction interface, an association relationship between the set of users and a current user satisfying a predetermined condition, the content item comprising a first control configured to trigger adjustment of the association relationship between the current user and a user corresponding to the content item;
presenting, in a first content item of the set of content items corresponding to a first user, a set of media contents associated with the first user; and
presenting, in response to a trigger for a first media content of the set of media contents, a playback interface of a media stream to play the first media content, the media stream corresponding to the set of media contents.

19. The electronic device of claim 18, wherein the acts further comprise:
ceasing, in response to receiving a second operation, presentation of the first content item, the second operation being associated with the first content item.

20. A non-transitory computer-readable storage medium having a computer program stored thereon, wherein the computer program is executable by a processor to perform acts comprising:
presenting a set of content items corresponding to a set of users in an interaction interface, an association relationship between the set of users and a current user satisfying a predetermined condition, the content item comprising a first control configured to trigger adjustment of the association relationship between the current user and a user corresponding to the content item;
presenting, in a first content item of the set of content items corresponding to a first user, a set of media contents associated with the first user; and
presenting, in response to a trigger for a first media content of the set of media contents, a playback interface of a media stream to play the first media content, the media stream corresponding to the set of media contents.
